(19) United States
(12) Patent Application Publication
(10) Pub. No.: US 2026/0175455 A1
(43) Pub. Date: Jun. 25, 2026

(54) A MOBILE ROBOT

(71) Applicant: HangZhou YuShu TECHNOLOGY CO.,LTD., Hangzhou, Zhejiang (CN)

(72) Inventors: Xingxing WANG, Hangzhou, Zhejiang (CN); Kai WANG, Hangzhou, Zhejiang (CN)

(21) Appl. No.: 19/128,496

(22) PCT Filed: Jun. 29, 2023
(86) PCT No.: PCT/CN2023/103702

§ 371 Date: May 8, 2025

(30) Foreign Application Priority Data
Nov. 25, 2022 (CN) 202211489002.2

(51) Int. Cl. B25J 19/02; B25J 5/00; B25J 19/00

(52) U.S. Cl. CPC B25J 19/022; B25J 5/007; B25J 19/0091; B25J 19/023

(57) ABSTRACT

A mobile robot includes a body and a wide-angle LiDAR, the body being in the shape of a vertically-placed hemi-elliptical sphere having a narrower upper portion and a broader lower portion, the wide-angle LiDAR being provided above the body, and the projection of the installation position of the wide-angle LiDAR being located near the geometric center of the body. The body is shaped as a vertically-placed hemi-elliptical sphere having a narrower upper portion and a broader lower portion, and the wide-angle LiDAR is located right above the body; and such a matching and configuration mode only requires one wide-angle LiDAR to achieve wider-range sensing of the surrounding environment of the body, achieving low production and manufacturing costs, and avoiding the problem of processing data of a plurality of sensing devices, thus reducing the data processing difficulty.

### TECHNICAL FIELD

The present application relates to the technical field of robotic apparatuses, and in particular, to a mobile robot.

### BACKGROUND

Currently, a mobile robot is installed with many sensing devices in all directions of its body to sense surroundings around the mobile robot.

Chinese Patent Application No. 2020218038837 discloses a ultra-wide-viewing-angle quadrupedal robot, including a body having an accommodating cavity, a head provided at an end of the body, a tail, and legs assembled with the body; the legs and the underside of the body form a blind zone between the abdomen of the robot and the ground; one, two or all of the body, head, tail, and legs is/are assembled with a wide-angle lens or fisheye lens capable of scanning ground information or/and information on obstacles surrounding the robot; and the wide-angle lens or fisheye lens is mounted facing downward or tilting downward and has view covering the blind zone between the abdomen and ground.

In the above-described technical solution, the body is a square structure, so that the wide-angle lens or fisheye lens has relatively severe blocked view regardless of its installation position at the body, being unable to obtain environmental information around the body in a relatively large range.

Further, in the above technical solution, a plurality of wide-angle lenses or fisheye lenses are provided to obtain as much environmental information as possible in all directions of the quadrupedal robot, which substantially increase the sensing capability of the quadrupedal robot, but also increases production costs, and data processing difficulty.

The information disclosed in the background is only used to clarify the background of the present inventive concept, and thus, may include the information that does not constitutes the prior art.

### BRIEF SUMMARY

Given one or all of the problems described above, object I of the present application is to provide a mobile robot, and on its body, a wide-angle LiDAR is installed to acquire environmental information around the body in a relatively large range.

Given one or all of the problems described above, object II of the present application is to provide a mobile robot, its body is set as a thin-above thick-below geometric body, and a wide-angle LiDAR is provided above the body. The body that is thin above and thick below can effectively reduce blocking to the wide-angle LiDAR, so that the wide-angle LiDAR has a relatively large view range, and can effectively acquire environmental information around the body in a relatively large range. The solution is simple and practical, being easy to produce with a low manufacturing cost.

Given one or all of the problems described above, object III of the present application is to provide a mobile robot, its body is set as a thin-above thick-below geometric body, a lens is assembled at a thin end of the geometric body, and thus blocking to the view of the lens can be effectively reduced, so that the lens has a relatively large view range, and can effectively acquire environmental information around the body in a relatively large range.

To realize one of the above objects, a first technical solution of the present application is:
a mobile robot, including a body and a wide-angle LiDAR,
the body having a shape of a thin-above thick-below geometric body, and the wide-angle LiDAR being disposed almost above the body.

The present application, by continuous exploration and experimentation, sets the body as a thin-above thick-below geometric body, and sets the wide-angle LIDAR above the body. The body that is thin above and thick below can effectively reduce blocking to the wide-angle LiDAR, so that the wide-angle LiDAR has a relatively large view range, and can effectively acquire environmental information around the body in a relatively large range. The solution is simple and practical, being easy to produce with a low manufacturing cost.

As a preferred technical measure:
the body is a vertically placed semi-ellipsoidal sphere or cone-like body or truncated con; and
an axis of the wide-angle LIDAR is inclined towards a forward direction of the body to obtain a larger scanning area in the forward direction and enable a scanning center of the wide-angle LiDAR directly in front of the forward direction of the body.

The present application can realize sensing of environment around the body in a relatively large range by utilizing only one wide-angle LiDAR, with a low production cost, and does not relate to data processing problems for multiple sensing devices, reducing data processing difficulty.

Also, the installation direction of the wide-angle LiDAR is tilted toward the forward direction of the body, being capable of acquiring environmental information in front of the body in a larger range. And also, the wide-angle LiDAR can meticulously scan the moving area directly in front of the robot with high resolution to help the robot in motion and obstacle avoidance.

As a preferred technical measure:
the body is provided with a support, by which the wide-angle LiDAR is fixed almost above the body. The support is relatively small and hardly block the scan viewing angle of the LiDAR, and thus, the ground and surrounding conditions around the robot is detected in real time.

The support is an n-shaped structure or a rod-like structure or an inverted L-shaped structure, further reducing blocking to the view of the wide-angle LiDAR.

As a preferred technical measure:
a panoramic camera is provided above the body or the wide-angle LiDAR, and the panoramic camera has a main viewing angle towards the forward direction of the body. The panoramic camera provided above the body may acquire more environmental information around the body. With a large viewing angle, a simple structure, a low cost and a high reliability, the robot can realize omni-directional image collection.

As a preferred technical measure:
the panoramic camera is fixed to a peak point of the mobile robot; or
the panoramic camera is fixed directly on the support or to the top of the body; and/or,
a bottom of the body is provided with a mobile device for driving movement of the body, and a suspension device for vibration damping is provided between the mobile device and the body.

As a preferred technical measure:
the mobile device comprises a first driving wheel and a second driving wheel providing power, and a driven wheel assisting in steering, the first driving wheel and second driving wheel rotating at differential speeds to steer the body.

As a preferred technical measure:
the driven wheel is a driven omni-directional wheel or a driven universal wheel, the driven omni-directional wheel, and the first drive wheel and the second drive wheel are arranged in a “□”-shape at the bottom of the body; and the driven universal wheel, and the first driving wheel and second driving wheel are arranged in a “ [symbol] ”-shape at the bottom of the body; or only one driven omni-directional wheel and one driven universal wheel are provided, and the driven omni-directional wheel, and the first drive wheel and the second drive wheel are arranged in a “T”-shape at the bottom of the body; and the driven universal wheel, and the first driving wheel and second driving wheel are arranged in a “T”-shape at the bottom of the body.

To realize one of the above objects, a second technical solution of the present application is:
a mobile robot, including a body provided with an accommodating cavity and a lens for acquiring external information; and
the body being a thin-above thick-below geometric body, above which or an upper end of which the lens is mounted.

The present application, by continuous exploration and experimentation, sets the body as a thin-above thick-below geometric body, and assembles the lens at the thin end of the geometric body, thereby being capable of effectively reducing blocking to the view of the lens, so that the lens has a relatively large view range, and may effectively acquire environmental information around the body in a relatively large range. The solution is simple and practical, being easy to produce with a low manufacturing cost.

As a preferred technical measure:
the lens is a wide-angle LiDAR or a panoramic camera or a fisheye lens; and
the body has a smooth continuous transition from an upper surface to a lower surface, enabling good visual feeling with a beautiful structure, and easy application.

As a preferred technical measure:
the lens is fixed by a support at a position around a center above the body;
a height of the body is H; and a lower surface area of the body is 2-8 times an upper surface area of the body, which, on the one hand, can satisfy the need to reduce blocking to the view of the lens, and on the other hand, enables an aesthetic structure of the body with good visual feeling.

A height of the support projecting from the body is h, which, in conjunction with the thin-above thick-below geometric body, allows the view of the lens having a blocked range less than 90 degrees, further reducing blocking to the view of the wide-angle LIDAR, enabling a simple, practical solution.

$$The H = A * h ; and$$

$$1.5 ⩽ A ⩽ 5.$$

Such a cooperative setting manner requires only one wide-angle LiDAR to realize sensing of environment around the body in a relatively large range, with a low production cost, and without data processing issues for multiple sensing devices to reduce data processing difficulty.

The beneficial effect of the present application is as follows.

The present application, by continuous exploration and experimentation, sets the body as a thin-above thick-below geometric body, and sets the wide-angle LiDAR above the body. The body that is thin above and thick below can effectively reduce blocking to the wide-angle LiDAR, so that the wide-angle LiDAR has a relatively large view range, and can effectively acquire environmental information around the body in a relatively large range. The solution is simple and practical, being easy to produce with a low manufacturing cost.

The present application, by continuous exploration and experimentation, sets the body as a thin-above thick-below geometric body, and assembles the lens at the thin end of the geometric body, thereby being capable of effectively reducing blocking to the view of the lens, so that the lens has a relatively large view range, and may effectively acquire environmental information around the body in a relatively large range. The solution is simple and practical, being easy to produce with a low manufacturing cost.

Further, the present application provides the mobile robot in which the body has the shape set as the vertically placed, thin-above thick-below semi-ellipsoidal sphere, and the position of the wide-angle LiDAR is placed at the position directly above the body. Such a cooperative setting manner requires only one wide-angle LiDAR to realize sensing of environment around the body in a relatively large range, with a low production cost, and without data processing issues for multiple sensing devices to reduce data processing difficulty.

The present application is described in further detail below in conjunction with the figures and detailed description.

### BRIEF DESCRIPTION OF THE DRAWINGS

FIG. 1 is a schematic diagram of an embodiment of the present application;

FIG. 2 is a schematic diagram of another embodiment of the present application;

FIG. 3 is a schematic diagram of one of point cloud distribution maps collected by a wide-angle LiDAR of the present application;

FIG. 4 is a schematic diagram of a visual field range of a wide-angle LIDAR of the present application;

FIG. 5 is a schematic diagram of a visual field range of a panoramic camera of the present application; and

FIG. 6 is a schematic diagram of an assembly position of a panoramic camera of the present application.

In the figure: 1. body; 2. wide-angle LiDAR; 3. panoramic camera; 4. support; 5. driven omni-directional wheel; 6. first driving wheel; 7. second driving wheel; 8. driven universal wheel.

### DETAILED DESCRIPTION OF THE DISCLOSURE

Hereinafter, the present application is further described in conjunction with the figures and the detailed description. It should be noted that, without contradiction, embodiments or technical features described below may be subjected to any combination to form a new embodiment.

It should be noted that when two elements are “fixedly connected”, the two elements may be directly connected or there may be an intermediate element. Conversely, when an element is referred as “being directly on” another element, there is no intermediate element. Terms “upper”, “lower”, and similar expressions used herein are for illustrative purposes only.

Unless otherwise defined, all technical and scientific terms used herein have the same meaning generally understood by those skilled in the field of the present application. Terms used herein are for the purpose of describing specific embodiments only and are not intended to limit the application. The term “or/and” used herein includes any and all combinations of one or more relevant listed items.

A first specific embodiment of a mobile robot of the present application is:
a mobile robot including a body provided with an accommodating cavity and a lens for acquiring external information; and
the body being a thin-above thick-below geometric body, above which or an upper end of which the lens is mounted.

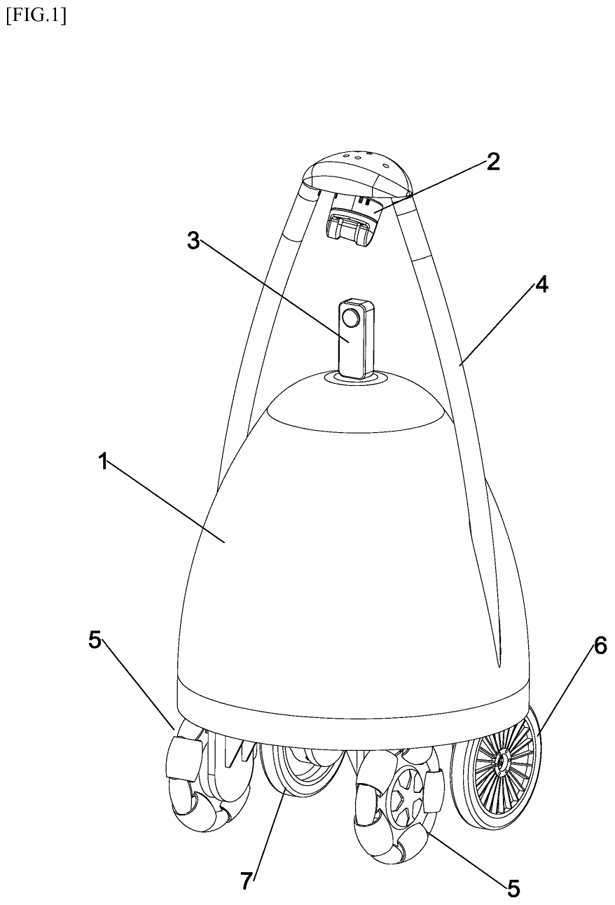

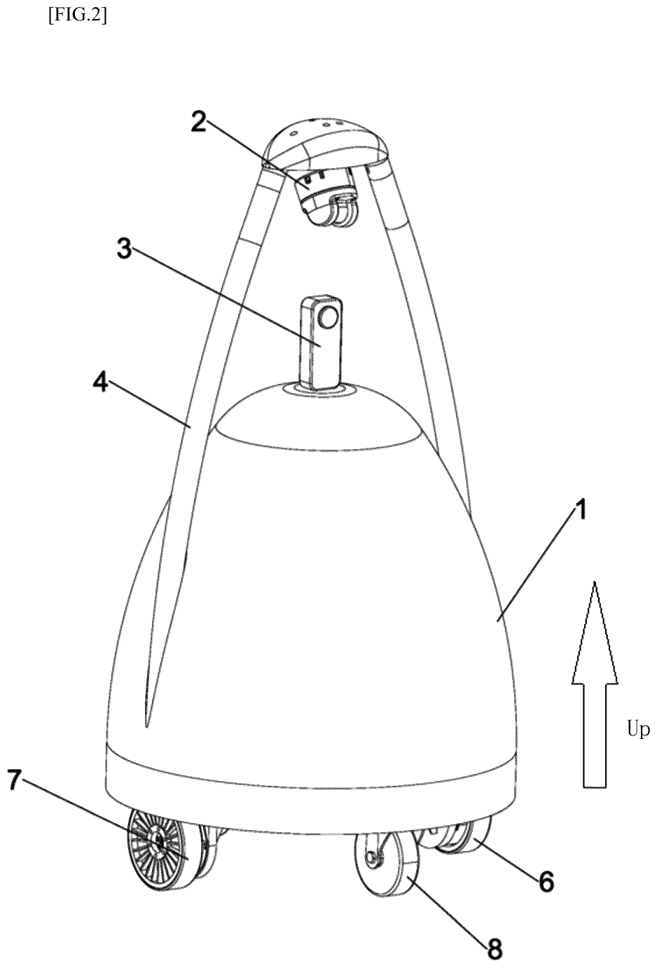

Referring to FIGS. 1 and 2, a second specific embodiment of the mobile robot of the present application is:
a mobile robot including a body 1 and a wide-angle LiDAR 2, the body 1 having a shape of a thin-above thick-below geometric body with a continuous transition, and the wide-angle LIDAR 2 being provided above the body 1. The projection of the installation position of the wide-angle LiDAR 2 does not need to be located exactly at the geometric center of the body 1, but, the wide-angle LiDAR, only in combination with a plurality of groups of ultrasonic sensors, a plurality of groups of depth cameras, a collision sensor, a 2D or 3D conventional LiDAR, etc., can monitor in real time the terrain and obstacles near and away from the perimeter of the robot.

In a specific embodiment of the structure of the body 1 of the present application:
the body 1 is one of a semi-ellipsoidal sphere, a cone-like body, and a truncated cone that are vertically placed.

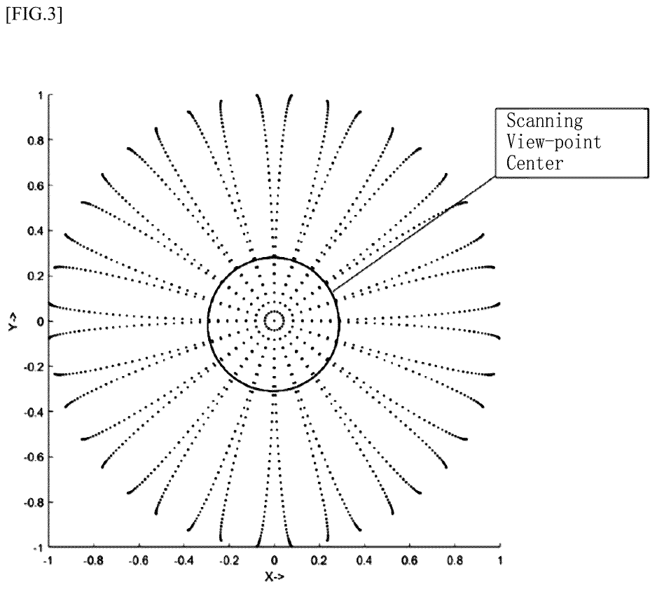

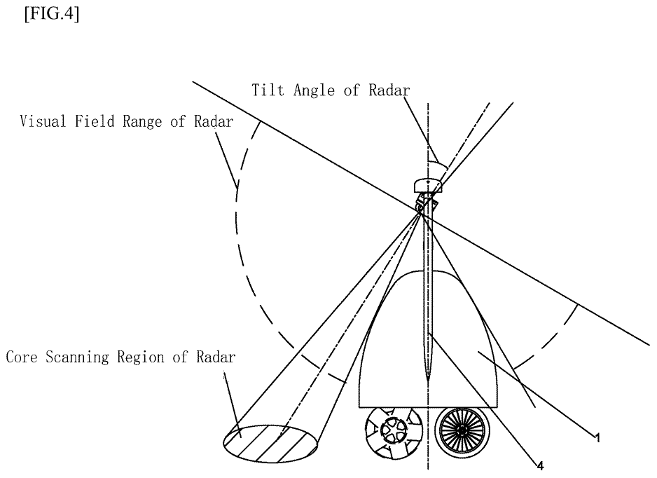

Referring to FIGS. 3 and 4, in a specific embodiment of the wide-angle LiDAR 2 of the present application,
an axis of the wide-angle LiDAR 2 is inclined towards a forward direction of the body 1 to obtain a larger scanning area in the forward direction and enable a scanning center of the wide-angle LIDAR 2 directly in front of the forward direction of the body 1. The installation direction of the wide-angle LIDAR 2 is tilted toward the forward direction of the body 1, being capable of acquiring environmental information in front of the body 1 in a larger range. And also, the wide-angle LiDAR 2 can meticulously scan the moving area directly in front of the robot with high resolution to help the robot in motion and obstacle avoidance.

In a specific embodiment of the present application with an additional support 4:
the body 1 is provided with a support 4, by which the wide-angle LiDAR 2 is fixed almost above the body 1. The support 4 is relatively small and hardly block the scan viewing angle of the LiDAR, and thus, the ground and surrounding conditions around the robot is detected in real time.

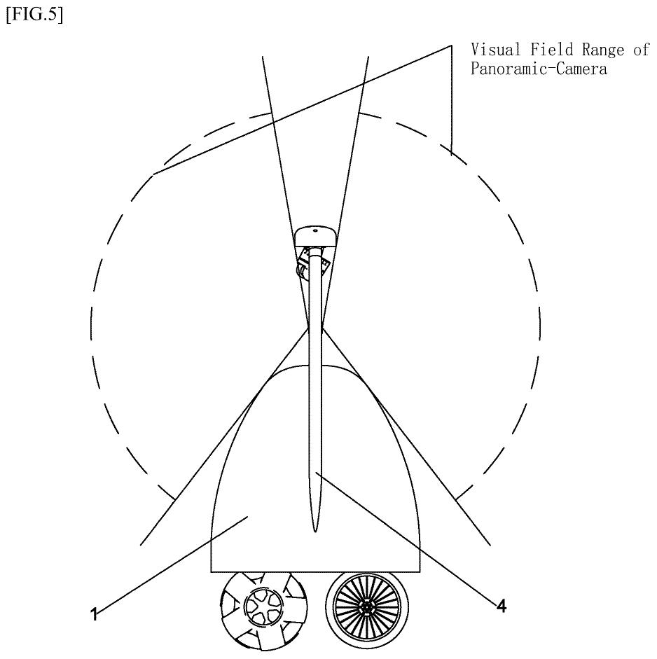

Referring to FIG. 5, in a specific embodiment of the present application with an addition panoramic camera 3:
a panoramic camera 3 is provided above the body 1 or the wide-angle LiDAR 2, and has a main viewing angle towards the forward direction of the body 1. The panoramic camera 3 provided above the body 1 may acquire more environmental information around the body 1. With a large viewing angle, a simple structure, a low cost and a high reliability, the robot 2 can realize omni-directional image collection.

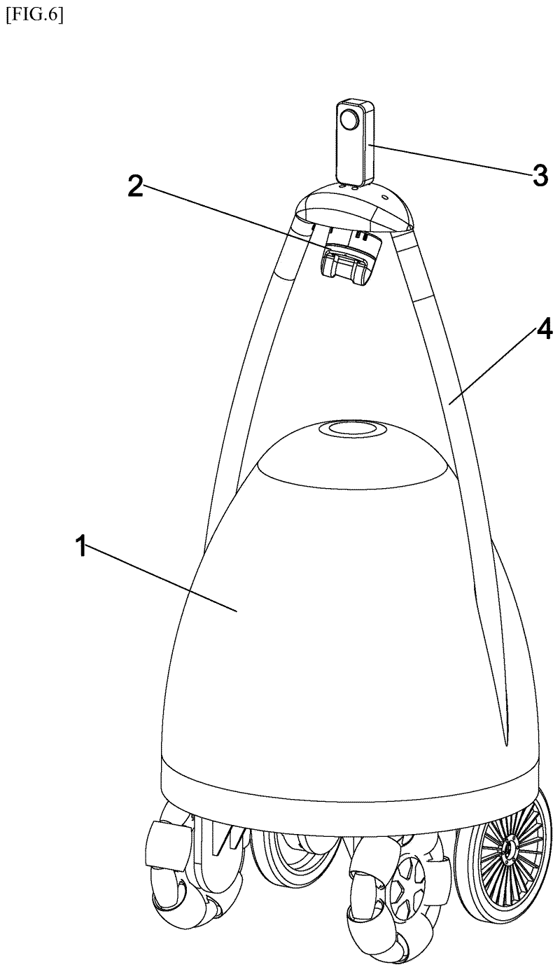

Referring to FIG. 6, in a first specific embodiment of the assembly position of the panoramic camera 3 of the present application:
the panoramic camera 3 is fixed to a peak point of the mobile robot.

In a second specific embodiment of the assembly position of the panoramic camera 3 of the present application:
the panoramic camera 3 is fixed directly on the support 4 or to the top of the body 1.

In a specific embodiment of the present application with an additional mobile device:
a bottom of the body 1 is provided with a mobile device for driving movement of the body 1, and a suspension device for vibration damping between the mobile device and the body 1.

The mobile device includes a first driving wheel 6 and a second driving wheel 7 providing power, and a driven wheel assisting in steering, and the first driving wheel 6 and second driving wheel 7 rotate at differential speeds to steer the body 1.

The driven wheel is a driven omni-directional wheel 5 or a driven universal wheel 8, the driven omni-directional wheel 5, and the first drive wheel 6 and the second drive wheel 7 are arranged in a “□”-shape at the bottom of the body (1); and the driven universal wheel 8, and the first driving wheel 6 and second driving wheel 7 are arranged in a “ [symbol] ”-shape at the bottom of the body.

In the present application, a fixed-connection manner may be screwed or welded or riveted or plugged or connected by a third component, which may be selected by those skilled in the art as needed.

Finally, it should be noted that the above embodiments are only used to illustrate the technical solution of the present application and are not intended to limit the present application, although the present application is described in detail with reference to the above embodiments, those of ordinary skill in the art should understand that the specific embodiments of the present application can still be modified or equivalently replaced, and any modification or equivalent replacement which does not depart from the spirit and scope of the present application shall be covered by the scope of protection of the claims in the present application.

1. A mobile robot, comprising a body and a wide-angle LIDAR, the body having a shape of a thin-above thick-below geometric body, and the wide-angle LIDAR being disposed almost above the body.

2. A mobile robot according to claim 1, wherein the body is a vertically placed semi-ellipsoidal sphere or cone-like body or truncated cone; and
an axis of the wide-angle LiDAR is inclined towards a forward direction of the body to obtain a larger scanning area in the forward direction and enable a scanning center of the wide-angle LiDAR directly in front of the forward direction of the body.

3. A mobile robot according to claim 2, wherein the body is provided with a support by which the wide-angle LiDAR is fixed almost above the body; and
the support is an n-shaped structure or a rod-like structure or an inverted L-shaped structure.

4. A mobile robot according to claim 1, wherein a panoramic camera is provided above the body or the wide-angle LiDAR, the panoramic camera having a main viewing angle towards the forward direction of the body.

5. A mobile robot according to claim 4, wherein the panoramic camera is fixed to a peak point of the mobile robot; or
the panoramic camera is fixed directly on the support or to the top of the body; and/or,
a bottom of the body is provided with a mobile device for driving movement of the body, and a suspension device for vibration damping is provided between the mobile device and the body.

6. A mobile robot according to claim 5, wherein the mobile device comprises a first driving wheel and a second driving wheel providing power, and a driven wheel assisting in steering, the first driving wheel and second driving wheel rotating at differential speeds to steer the body.

7. A mobile robot according to claim 6, wherein the driven wheel is a driven omni-directional wheel or a driven universal wheel, the driven omni-directional wheel, and the first drive wheel and the second drive wheel are arranged in a “□”-shape at the bottom of the body; and the driven universal wheel, and the first driving wheel and the second driving wheel are arranged in a “ [symbol] ”-shape at the bottom of the body; or
only one driven omni-directional wheel and one driven universal wheel are provided, and the driven omni-directional wheel, and the first drive wheel and the second drive wheel are arranged in a “T”-shape at the bottom of the body; and the driven universal wheel, and the first driving wheel and the second driving wheel are arranged in a “T”-shape at the bottom of the body.

8. A mobile robot, wherein
a body provided with an accommodating cavity and a lens for acquiring external information are comprised; and
the body is a thin-above thick-below geometric body, above which or an upper end of which the lens is mounted.

9. A mobile robot according to claim 8, wherein
the lens is a wide-angle LiDAR or a panoramic camera or a fisheye lens; and
the body has a smooth continuous transition from an upper surface to a lower surface.

10. A mobile robot according to claim 8, wherein
the lens is fixed by a support at a position around a center above the body;
a height of the body is H; and a lower surface area of the body is 2-8 times an upper surface area of the body; and
a height of the support projecting from the body is h, which, in conjunction with the thin-above thick-below geometric body, allows the view of the lens having a blocked range less than 90 degrees;
$$where the H = A * h ; and$$
$$1.5 \leq A \leq 5 .$$
